(19) United States
(12) Patent Application Publication
(10) Pub. No.: US 2026/0051166 A1
(43) Pub. Date: Feb. 19, 2026

(54) INTERCHANGEABLE PAYLOAD MULTI-PURPOSE SYSTEM AND METHOD FOR MONITORING A GRASS-TURF AND BROADCASTING

(71) Applicants: Ira DVIR, Beer Yaakov (IL); Ilia BAKAROV, Kiriyat Ono (IL)

(72) Inventors: Ira DVIR, Beer Yaakov (IL); Ilia BAKAROV, Kiriyat Ono (IL)

(21) Appl. No.: 19/107,483

(22) PCT Filed: Jul. 5, 2023
(86) PCT No.: PCT/IL2023/050698

§ 371 Date: Feb. 27, 2025

Related U.S. Application Data
(60) Provisional application No. 63/404,723, filed on Sep. 8, 2022.

(51) Int. Cl. G06V 20/10; B25J 9/00; G06V 20/40; G06V 20/52

(52) U.S. Cl. CPC G06V 20/188; B25J 9/0078; G06V 20/41; G06V 20/52

(57) ABSTRACT

A dual purpose 3D Cable-Cam System and method, the 3D Cable-Cam system comprising, a dolly having an interchangeable mount for coupling a Camera or Sensor, and a controlling device for conducting a scanning survey of sports-stadiums grass-turfs, collecting Imagery for monitoring the grass-turf condition and storing the Imagery for detailed analysis on a local or remote computing device or on the Cloud. The dolly may also include an ambient light sensor, an altitude meter and a spreading assembly.

### FIELD OF THE INVENTION

The present invention generally pertains to a system and method for monitoring the condition of the grass of grass-turfs and treating the grass by applying maintenance actions thereto, as required.

### BACKGROUND OF THE INVENTION

The grass-turf of sport stadiums demands careful maintenance. Baseball, tennis, soccer, American football, rugby, field hockey, cricket, and such sports, demand grass-turf of high quality. Maintaining the grass-turf requires in most cases the following actions:
1. Detecting post-match tears and damages;
2. Mowing;
3. Clipping Removal, i.e., sweep, vacuum, or otherwise remove clippings from the turf;
4. Fertilizing;
5. Overseeding with Perennial Ryegrass;
6. Coring;
7. Topdressing;
8. Thatch Removal;
9. Pesticide distribution;

Such maintenance actions are performed frequently. In many cases some of them are performed twice a week during the months of April through October or different months, depending on the global location. Such periodical examination and analysis of the health, stress, moisture, diseases, pests, etc., conditions of the grass-turf is essential for keeping the grass in top condition and vigor. Detecting and identifying every deficiency or irregularity of the grass-turf, which degrades the quality of the grass-turf, and treating it, is essential for having optimal surfaces for various events, such as sports events. Thus, it is important to detect and identify every phenomenon of the grass-turf that calls for treatment or maintenance, and the accurate location of a deficiency of the pitch.

Optimal scanning of the grass-turf can be done manually by an agronomist. However, such scanning will prove inefficient since there are numerous sport stadiums having a grass-turf wherein each such stadium consists of relatively a large grass-turf. The availability of agronomists for such a task is scarce and the cost is relatively high.

Another solution for scanning a grass-turf of a stadium is by a remote-controlled drone, which enables acquiring imagery at a nadir angle and from different altitudes (as disclosed in U.S. Pat. No. 10,943,114, the “Agrowing's Patent). A major disadvantage of this scanning method is that operating a drone in a stadium requires a qualified operator or an expensive autonomous system. Furthermore, flying a drone in a stadium where people and many obstacles are present is hazardous.

It is therefore a long felt need to have an inexpensive autonomous system for periodically conducting a scanning survey of a grass-turf at an optimal angle at any time and under any weather and lighting conditions, thereby monitoring the grass-turf and performing maintenance and treatment actions as required.

It is also a long felt need, that such autonomous system for grass-turf monitoring can be additionally used for broadcasting sports and other events, which take place on the grass-turf of stadiums, thus enhancing the viewing experience of television viewers by supplying images, which are acquired from points of view that are not available to cameras that are conventionally positioned outside the pitch.

### SUMMARY OF THE INVENTION

An efficient way to conduct a scanning survey of a grass-turf is by a system which utilizes an RGB/multispectral and/or hyperspectral and/or Lidar and/or IR cameras/sensors operating in an automated process. Such scanning survey can be conducted by using cameras/sensors, which are positioned on lighting-bearing towers/posts of the stadium. However, placing such cameras/sensors on the towers/posts of the stadium has a major disadvantage: the angle of the imagery acquisition by the cameras/sensors is inevitably an oblique angle. Imagery acquisition at an oblique angle is not suited for optimal analysis. When using a camera/sensor, which is positioned on a tower/lighting-post of the stadium, the distance of the tower/post from the central portions of the pitch significantly degrades the resolution and quality of the acquired imagery. For optimal analysis of the imagery the acquiring camera/sensor should be positioned at a nadir angle (i.e., zenith).

Thus, according to some embodiments of the present invention there is provided a cable system with an interchangeable and/or fixed camera or sensor payload, which enables acquiring imagery of the grass of grass-turfs of sports stadiums from a nadir angle, conducting an analysis of the imagery and spreading or spraying substances on areas of the pitch that require spreading or spraying of pesticides and/or water and/or nutrients, selectively and accurately according to the analysis.

According to some embodiments of the present invention, the cable system is adapted and configured for monitoring the condition of grass-turfs in general, and in particular grass-turfs of stadiums for sports or other events and maintaining and treating the grass-turfs as required, and also adapted and configured for enhancing video stream viewing of sports or other events, television shows, studio shows, and concerts. According to some embodiments of the present invention, the cable system comprises a “flying” camera or sensor coupled to at least four cables, each cable is coupled to a post or tower disposed at a corner of the pitch and can be pulled in the direction of that corner by a remote-controlled system (this cable system shall be referred to herein below as the “3D Cable-Cam System” or “3D cable system”).

According to some embodiments of the present invention, the 3D Cable-Cam System additionally comprises a dolly having a payload mount for interchangeably holding the camera or sensor. Alternatively, the dolly includes a gimbal stabilizer which is adapted and configured for coupling to the camera or sensor. The altitude of the camera or sensor is set by motorized winches, which operate on the cables to change their tension. The cables can be coupled to the dolly (i.e., a camera payload head). The higher the tension of the cables, the higher is the altitude position of the camera payload mounted on the dolly (up to the altitude of the hooks of the cables). An operator can position the camera payload for capturing images and video streams within a virtual rectangular “box” created by four hooks of the cables, by decreasing and increasing the tension of all the cables or of any one of them according to the desired location. Unified decreasing and increasing the tension of all the cables enables the operator to position the camera or sensor load at various altitudes thus creating the effect of a “flying” camera. This way, the 3D Cable-Cam System according to the invention enables the camera load to scan the grass-turf or follow the events on the grass-turf for example performance of athletes, from the air at various altitudes above any point of the pitch and from various angles and practically “fly” beside the performers as they run or dribble a ball or move on the pitch.

The control of the camera payload mounted on the 3D Cable-Cam System according to some embodiments of the present invention, is much like the control of a drone, which is confined to fly within a given virtual “box”. The peripheral four faces of the virtual “box” of the 3D Cable-Cam System according to the present invention, are defined by a virtual rectangular, which connects four anchors coupled to the cables. The top face of the virtual “box” is a virtual plane, which can be imagined as extending at the altitude of the anchors as vertexes or its top plane, and the bottom plane of the virtual “box” is provided by the pitch. The anchors of the cables can be attached to the lighting towers/posts or to the stands or roof of the stadium, or to dedicated posts adjacent to the pitch.

Presently, conventional cable camera systems are being installed temporarily upon demand for events and removed thereafter. The installation of such a system is complex and could take a day or two, as it includes the installation of hundreds of meters of optical wires and metal wires. This common practice makes sense when use of such a system is limited to two or three dozen events per season. However, implementing such a system for broadcasting the events on the pitch, for example the activities of sportsmen several times per week, or as many times as desired, makes the installation of a permanent cable camera system reasonable.

The current invention discloses a permanent 3D Cable-Cam System, that can be programmed and used autonomously for frequent scanning the grass-turf of sports stadiums over a long period of time (one or more sports seasons) from a fixed altitude and according to a pre-defined motion pattern, acquiring still images and/or video streams that cover the entire area of the grass-turf for the purpose of an in-depth analysis of its condition and at the same time scanning the grass-turf of sports stadiums over a long period of time according to a pre-defined motion pattern, acquiring still images and/or video streams and broadcasting them to audiences.

Since the exact location on the grass-turf of irregularities found thereon in a scanning survey is required, each of the acquired images can be geotagged. Accuracy of the geotagging can be achieved by a simple GPS or more accurately by PPK or RTK modules, which can provide an accuracy of 1-3 cm.

As an alternative method of referencing the geotagging can be based on a grid mapping of an acquired imagery. If for example, the entire pitch could be covered by a few hundred images (a soccer pitch will probably require a grid of 12×24 images, where each image covers an area of 5x5meters of the pitch), it is rather simple to calculate the actual pitch-position of every tear or other irregularity of the grass-turf, which has been detected according to its X:Y frame position, and its relative location in the image. In both scanning methods, with or without overlapping, either GPS or grid mapping can be used for accurate positioning.

The imagery can be acquired using a “mission plan” that travels or moves the camera load according to a pre-defined path, capturing the imagery as independent JPEG/RAW multispectral, and/or hyperspectral, and/or Lidar, and/or IR images. Alternatively, the imagery can be acquired as a video stream and extracted video frames can be used for the analysis of the gras-turf condition. According to the present invention, the path of the camera/sensor is defined in a way that allows side and top overlapping of the acquired imagery for the purpose of facilitating orthophoto stitching.

Alternatively, the path can be programmed to capture the imagery with no (or minimal) overlapping of the images, where the independent images can be positioned in a chessboard like grid, combined (if required for any reason) to display the entire image of the pitch.

Stitching RGB, multispectral and/or hyperspectral, and/or Lidar, and/or IR still images or a video stream to orthophoto/s of the stadium enables accurate positioning of the images without the need for GPS, as the orthophoto includes a pitch of known dimensions, and every pixel of the orthophoto can be attached to a specific spot of the pitch by simple triangulation. Alternatively, the acquired images can be stored on a multispectral sensor or camera's memory (SD or any other format memory or storage) or transmitted over wireless or wired electronic means or an optical fiber connection to be remotely stored and analyzed.

Alternatively, according to an embodiment of the present invention, the dolly of the 3D Cable-Cam System includes a mount for interchangeably coupling of payloads, e.g., a video broadcast camera and a multispectral sensor, and connectors.

Alternatively, according to an embodiment of the present invention, the camera load is a Dual-Purpose device, capable of acquiring video streams (even of broadcast quality, HD, 4K, 6K, 8K, 16K (and on) in 25 to 60 and even 120 fps) or multispectral imagery, with a simple interchange of the camera's lens. Such dual-purpose camera/sensor will enable the system according to the present invention to be used both for scanning and analyzing a grass-turf, and for providing video streams of sports/entertainment events for broadcasting.

In terms of costs, a static and/or permanent installation of a system according to the present invention, is justified mostly due to its dual-purpose function of video stream entertainment and grass-turf scanning. Based on the cost of such a system and its operation as compared to 15-20 installations per season plus the cost of conventional grass-turf monitoring, it is estimated that a fixed system according to the present invention will cover its cost within a single season, while having the benefit of superior quality scanning of the grass-turf at a constant low cost.

According to an embodiment of the invention, the 3D cable-system for collecting imagery of the grass-turf and or of events taking place thereon, comprises a cable assembly including a plurality of cables, each one of the cables is having a first end and a second end, a dolly, a plurality of computerized winches, each one of the plurality of winches is coupled to a post or tower, wherein the first end of each cable is coupled to at least one of the winches and the second end of each cable is coupled to the dolly. The 3D cable-system further comprises a camera or sensor payload mounted on the dolly and can acquire imagery including still images and/or video streams of the grass-turf and/or of events taking place thereon, for monitoring the condition of the grass-turf for detecting an irregularity and/or a deficient condition of the grass-turf comprising at least one member of a group consisting of tear, bad health, lack of vigor, dryness, wetness, nutrient deficiency, diseases and pests, and/or for providing video streams for broadcasting. The 3D cable-system further comprises a memory storage for storing the acquired imagery, a control device coupled to the dolly, the camera or sensor and at least one of the plurality of the winches, wherein the control device is adapted and configured for conducting a scan survey of at least a part of the grass-turf by moving the dolly and/or the camera or sensor over the at least a part of the grass-turf according to a pre-set plan, and/or for triggering the camera or sensor to acquire the Imagery. The 3D Cable-Cam System further comprises a processing device, adapted and configured for transmitting and/or for broadcasting of the imagery.

The 3D cable-system according to an embodiment of the invention, wherein the post or tower is disposed adjacent the grass-turf. The 3D cable-system according to an embodiment of the invention,, wherein the first end of each one of the cables is coupled to the post or tower via at least one of the plurality of motorized winches having a computerized controller and anchored to the post or tower. The 3D cable-system according to an embodiment of the invention, wherein the control device is coupled to the computerized controller and/or dolly and/or camera or sensor via at least one member of a group consisting of a wireless electronic means, an electric wire and an optical fiber connection, and wherein the computerized controller is adapted and configured for positioning the camera or sensor and/or dolly at a pre-set altitude over the grass-turf. The 3D cable-system according to an embodiment of the invention, wherein the processing device is adapted and configured for processing of the acquired imagery by using agricultural metrics comprising at least one member of a group including NDVI, ARVI, ENDVI, SAVI, TGI, CGI, MCGI, and/or any combination of these metrics, and by conducting bands separation and/or alignment and/or relative illumination correction and/or radiometric calibration, thereby detecting the irregularities and/or deficient condition of the grass-turf. The 3D cable-system according to an embodiment of the invention, wherein the processing device includes software adapted and configured for conducting an analysis of at least a part of the acquired imagery. The 3D cable-system according to an embodiment of the invention, wherein the dolly additionally comprises a payload mount adapted and configured for interchangeably mounting of the camera or sensor on the mount. The 3D cable-system according to an embodiment of the invention, wherein the camera or sensor is mounted on a gimbal stabilizer coupled to the dolly, the gimbal stabilizer being adapted and configured for stabilizing the camera or sensor at any desired angle including a nadir angle, thereby acquiring imagery from optimal angles of imagery acquisition. The 3D cable-system according to an embodiment of the invention, wherein the spreading assembly is formed as an integral part of the gimbal stabilizer, thereby providing pan and tilt of the spreading assembly allowing it to spread at a desired angle. The 3D cable-system according to an embodiment of the invention, wherein the spreading assembly further comprises a spraying pump mounted on the dolly and is adapted and configured for spraying liquids. The 3D cable-system according to an embodiment of the invention, wherein the camera or sensor payload is at least one member of a group of cameras or sensors comprising of an RGB, a multispectral, a hyperspectral, a Lidar and IR cameras or sensors, or any combination of the cameras or sensors, all operating in an automated process, and adapted and configured for acquiring the imagery of the grass-turf for detecting the irregularities and/or deficient condition of the grass-turf, and/or of events comprising at least one member of a group including sports, sport practice, games, events, all being conducted on the grass-turf, for broadcasting and/or documenting. The 3D cable-system according to an embodiment of the invention, wherein the camera or sensor payload comprises a dual-purpose camera or sensor capable of acquiring video streams or multispectral images by a simple interchange of a lens of the camera or sensor, and wherein the dual-purpose camera or sensor is adapted and configured for conducting a scanning survey of the grass-turf for monitoring the condition of the grass-turf, and for providing video streams of events taking place on the grass-turf for broadcasting. The 3D cable-system according to an embodiment of the invention, wherein the pre-set plan is adapted and configured for creating a virtual 3D box space over the grass-turf, for moving the dolly inside the box, by the control device. The 3D cable-system according to an embodiment of the invention, wherein the software is further adapted and configured for detecting the irregularity and/or an irrelevant object on an area of the at least part of the grass-turf, and for providing the control device with a scanning plan for conducting a re-requisition of the imagery of the irregularity and/or irrelevant object. The 3D cable-system according to an embodiment of the invention, further comprises a GPS module for documenting the GPS Guidance Package of every acquired still image of the scanning survey of the grass-turf, thereby determining the exact location of an irregularity and/or irrelevant object on the grass-turf and moving the camera or sensor to the area of the at least part of the grass-turf on which the irregularity and/or an irrelevant object has been detected for acquiring refined details for performing a “leaf-level” AI analysis. The 3D cable-system according to an embodiment of the invention, wherein the software is further adapted and configured for determining based on the analysis, to selectively spread on the area of the at least part of the grass-turf having the irregularity, at least one substance of a group comprising liquids, water, nutrients or pesticides; The 3D cable-system according to an embodiment of the invention, wherein the analysis is conducted by the software which is disposed in at least one member of a group comprising of the processor device, control device and/or a remote processor. The 3D cable-system according to an embodiment of the invention, wherein the software further includes a classifier for identifying the grass-turf irregularities. The 3D cable-system according to an embodiment of the invention, further comprising an ambient light sensor mounted on the dolly, the light sensor is coupled to the control device for sending a light data to the control device, wherein the data is used by the control device for determining whether to launch, cancel or postpone a scanning survey of the grass-turf according to pre-defined light conditions. The 3D cable-system according to an embodiment of the invention, further comprising a light module mounted on the dolly and coupled to the control device, the light module is adapted and configured for providing light in the NIR range, and includes at least one member of a group comprising a “Daylight TRI-R” led light element, a LED light element, a halogen light element, an incandescent light element, or any combination of the light elements, wherein the light module enhances the light on the grass-turf, thereby allowing to conduct the scanning survey of the grass-turf under low light conditions or at night. The 3D cable-system according to an embodiment of the invention, further comprising an altitude meter mounted on the dolly and coupled to the control device, the altitude meter is adapted and configured for measuring the altitude of the camera or sensor above the grass-turf, and for providing data of the altitude of the camera or sensor to the control device, thereby positioning the camera or sensor at an altitude according to the pre-set plan of the scanning survey of the grass-turf.

It is another object of the present invention to disclose a method for monitoring a grass-turf and or events taking place thereon, the method comprising the steps of providing a cable assembly including a plurality of cables, each one of the cables is having a first end and a second end, a dolly, a plurality of computerized winches, wherein each one of the plurality of winches is coupled to a post or tower and wherein the first end of each cable is coupled to at least one of the computerized winches and the second end of each cable is coupled to the dolly. The method according to the invention, further include the steps of providing a camera or sensor payload mounted on the dolly, acquiring by the camera or sensor imagery including still images and/or video streams of the grass-turf and/or of events taking place thereon, monitoring the condition of the grass-turf, detecting an irregularity and/or a deficient condition of the grass-turf comprising at least one member of a group consisting of tear, bad health, lack of vigor, dryness, wetness, nutrient deficiency, diseases and pests and/or providing video streams for broadcasting. The method according to the invention, further including the steps of providing a memory storage for storing the acquired imagery, providing a control device and coupling the control device to the dolly and/or the camera or sensor and/or the at least one of the computerized winches. The method according to the invention, further including the steps of conducting by the control device a scanning survey of at least a part of the grass-turf by moving the dolly and/or the camera or sensor over the at least a part of the grass-turf according to a pre-set plan, and/or triggering by the control device the camera or sensor for acquiring the imagery, and providing a processing device, adapted and configured for transmitting and/or for broadcasting of the imagery.

The method according to the invention, additionally comprising the step of conducting an analysis of at least a part of the acquired imagery by software adapted and configured therefor. The method according to the invention, additionally comprising the step of positioning the at least a part of the acquired imagery and creating an orthophoto by stitching. The method according to the invention, wherein the step of positioning includes positioning the at least a part of the acquired imagery according to chessboard like grid mapping. The method according to the invention, wherein the step of positioning alternatively includes positioning the images according to GPS or grid mapping. The method according to the invention, additionally comprising a step of controlling the path of motion of the camera or sensor and/or the dolly. The method according to the invention, wherein the step of controlling includes controlling the path of motion of the camera or sensor for acquiring the imagery with minimal side and top overlapping of images. The method according to the invention, additionally comprising a step of storing the acquired imagery.

It is another object of the present invention to disclose an autonomously method for monitoring a grass-turf and or events taking place thereon, the method comprising the steps of conducting a scanning survey by a camera or sensor of at least part of the grass-turf and/or the events, controlling the path of motion of the camera or sensor, acquiring images of the at least part of the grass-turf and/or the events, storing the acquired images, positioning the acquired images, stitching the acquired images, detecting areas of the at least part of the grass-turf and/or the events suspected of being damaged or in a deficient condition. The method according to the invention, wherein the step of detecting includes a step of analyzing the acquired images. The method according to the invention, additionally comprising a step of performing maintenance actions according to the scanning survey as necessary to keep the areas in optimal condition. The method according to the invention, wherein the step of analyzing includes a step of determining the maintenance actions necessary to perform on or to the areas.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a 3D Cable-Cam System according to the present invention.

FIG. 2 is an illustration of a nadir angle of view and an oblique angle of view.

FIG. 3 is a schematic illustration of a grid of a method of scanning a grass-turf pitch according to some embodiments of the present invention.

FIG. 4 is a schematic illustration of a 3D Cable-Cam System when used for image capturing at various altitudes of a grass-turf in RGB or multispectral mode.

FIG. 5 is a schematic illustration of a scan with top and side overlapping (left) Vs. accurate chessboard like grid imagery acquisition scanning survey (right).

FIG. 6 is an illustration of a 3D Cable-Cam System connected to a stadium's lighting posts.

FIG. 7 is an illustration of a dolly having a gimbal stabilizer, a camera/sensor in a nadir angle, an ambient light sensor, and an altitude meter.

FIG. 8 is an illustration of a dolly with a spreading assembly and a liquid container.

FIG. 9 is an illustration of graphs, which present the spectra range of daylight and of artificial light sources.

FIG. 10a is an illustration of narrow spectral bands.

FIG. 10b is an illustration of a multispectral sensor or Camera, which includes a wide RGB band as well as narrow spectral bands.

### DETAILED DESCRIPTION OF EMBODIMENTS OF THE INVENTION

The present invention, according to an embodiment, relates to a method and system for scanning a grass-turf in general and in particular a grass-turf of stadiums for sports events and other events, acquiring imagery, storing the acquired imagery, analyzing the imagery for determining the condition of the grass-turf and maintaining it as required, by utilizing a 3D single and/or dual-purpose cable-cam system or as referred herein above by a 3D Cable-Cam System. Alternatively, the analysis of the acquired imagery can be done on independent images or on the orthophoto of the scanned grass-turf. Alternatively, the analysis can be made locally e.g. by software in the processing device or the control device or remotely, e.g., by software on a remote processor for example, the Cloud. Alternatively, the analysis can be based on a single imagery acquisition session from a given altitude, which provides detailed data sufficient for the analysis, or based on remote and close imagery acquisitions (as disclosed in Agrowing's Patent).

According to an embodiment of the present invention, the 3D Cable-Cam System provides for focused spraying and/or spreading of pesticides or nutrients or water on desired locations of the grass-turf.

According to an embodiment of the present invention, the inventive system comprises a 3D Cable-Cam System 10, as shown in FIG. 1. The 3D Cable-Cam System 10 of the present invention includes a cable assembly having at least four cables 12, which are coupled to motorized winches (not shown) preferably via pullies 14. The winches or pullies are anchored to posts or towers 16, which are positioned on the periphery of the grass-turf in such a way that they create a virtual 3D box space, inside of which a Camera or Sensor, as defined below, can be controlled and moved.

The 3D Cable-Cam System 10 of the present invention further includes a control device (not shown) which is coupled to the motorized winches and alternatively, to the camera-load either via wireless electronic means or electric wire 48 or via an optical fiber connection (not shown). The control device is adapted and configured for providing a pre-set plan of a scanning survey of a pre-defined area of a gras-turf at a pre-set altitude from which the scanning is conducted, and for triggering a video and/or still image camera and/or a standard or conventional broadcast video camera and/or an RGB, multispectral, hyperspectral camera or sensor and/or video broadcast camera, and/or an Infra-Red camera and/or a Lidar sensor, or any combination of these cameras, as shown in FIG. 1 (all and any one of these cameras, shall be referred to herein above and below as “Camera or Sensor 22” or “camera or sensor”). Camera or Sensor 22 is adapted and configured for acquiring still images and/or video streams (which shall be referred to herein above and below as “Imagery” or “imagery”) and storing the Imagery in an internal storage memory of Camera or Sensor 22 and/or in a remote memory storage (not shown).

The 3D Cable-Cam System further includes a processing device (not shown) for pre-processing of the Imagery, including bands separation and alignment, relative illumination correction and radiometric calibration; and software adapted and configured for analyzing independent images of a scanning survey of grass-turf 11 or of an orthophoto, which is stitched from these images (which shall be referred to herein as the “Analyzing Software” or “analyzing software”).

The 3D Cable-Cam system 10 of the present invention further includes a dolly 18, which is coupled to at least four cables 12, as clearly shown in FIG. 7; a gimbal stabilizer 20 as shown in FIG. 7, which is coupled to the dolly. Camera or Sensor 22 is coupled to gimbal 20. Camera or Sensor 22 is adapted and configured for transmitting the acquired imagery over wireless or wired connection 48 to a remote storage. Additionally, the 3D Cable-Cam system 10 of the present invention includes a processing device (not shown) adapted and configured for pre-processing, or alternatively processing, the acquired Imagery by using agricultural metrics such us NDVI, ARVI, ENDVI, SAVI, TGI, CGI, MCGI, and the like, for analyzing and detecting possible damage or irregularities of the grass-turf and/or deficient conditions of the grass-turf, such as tears, bad health, lack of vigor, dryness, wetness, nutrient deficiency, diseases and pests, and for marking areas in the grass-turf, which are suspected of being damaged or in a deficient condition and require additional detailed examination.

According to an embodiment of the present invention, the standard or conventional broadcast video camera of Camera or Sensor 22 is adapted and configured for acquiring the Imagery not only of grass-turf 11 for detecting possible damage to the grass-turf but also of sports games and/or sports practice and/or other events being conducted on a grass-turf for broadcasting and/or documenting these events.

According to an embodiment of the present invention, the Analyzing Software is further adapted and configured for moving the Camera or Sensor 22 to areas of the grass-turf suspected of being deficient for a closer examination at a low altitude, which can be of 1-3 meters, if required, for acquiring refined details for performing “leaf-level” AI analysis. Camera or Sensor 22 is moved to the suspected areas based on GPS location and/or predefined grid position and triangulation.

According to some embodiments of the present invention, since the area of the pitch is relatively small, mostly a single hectare or less, the scanning is performed in a single pass at a low altitude of 3-5 m.

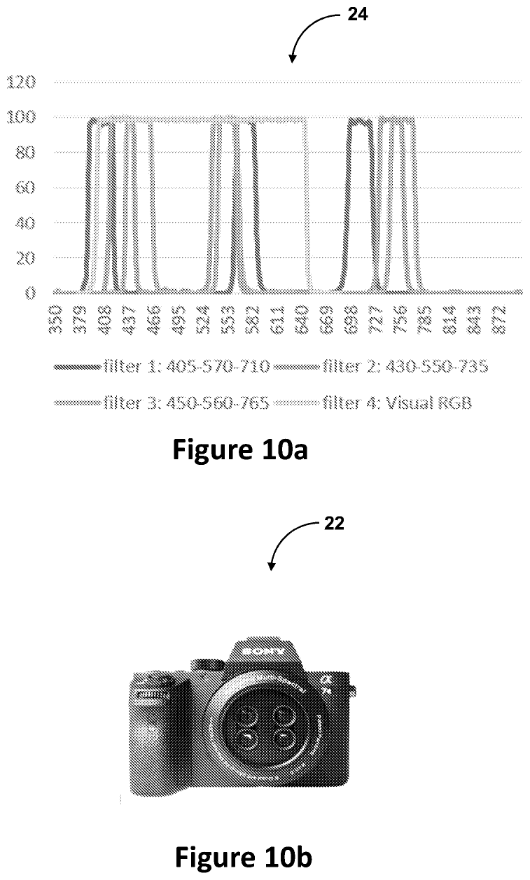

Alternatively, in some embodiments of the present invention, the multispectral of Camera or Sensor 22, as shown in FIG. 10b, includes in addition to narrow spectral bands 24, as shown FIG. 10a, a wide RGB band, avoiding the need to include an RGB camera in addition to the multispectral Camera or Sensor 22.

Alternatively, the still image camera and/or multispectral and/or hyperspectral camera of Camera or Sensor 22, may also comprise an Infra-Red camera and/or a Lidar sensor, or any combination thereof. A Lidar sensor can provide an accurate measurement of the height of the grass of the grass-turf and a better 3D presentation. The Infra-Red sensor can also provide additional valuable data. The narrow spectral bands 24 are aligned and resized to generate a “spectral cube”, if required.

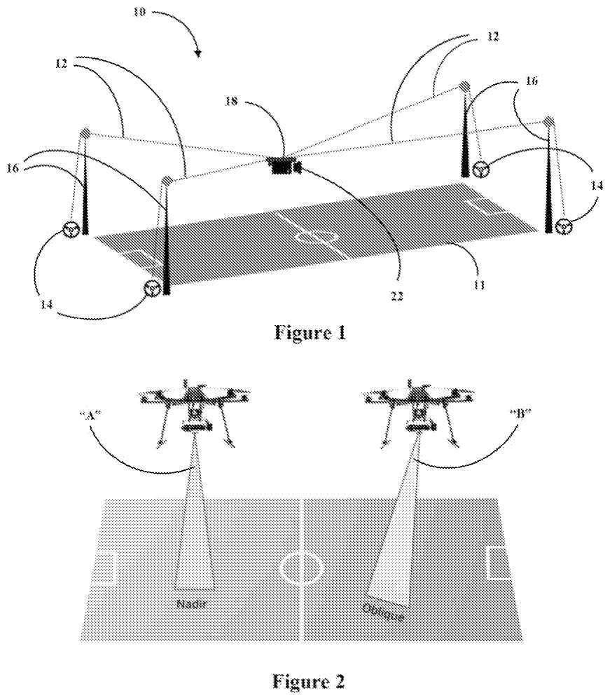

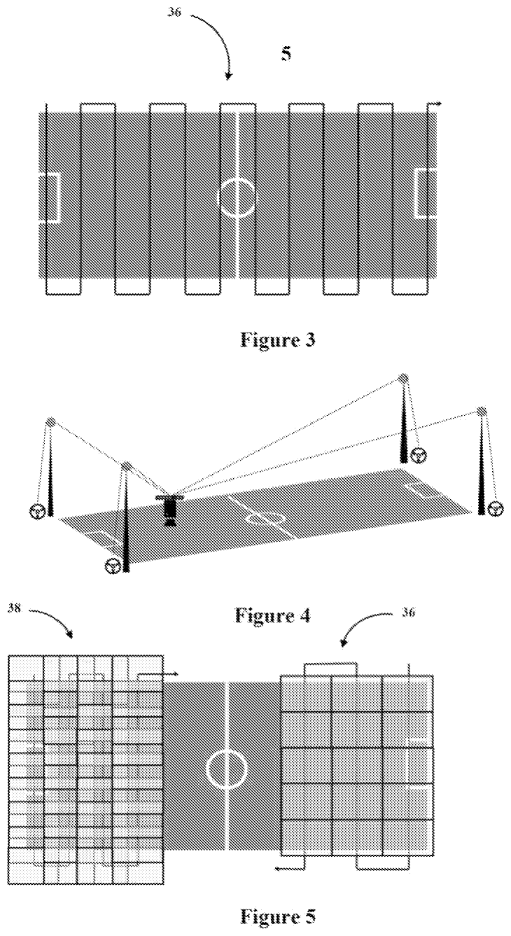

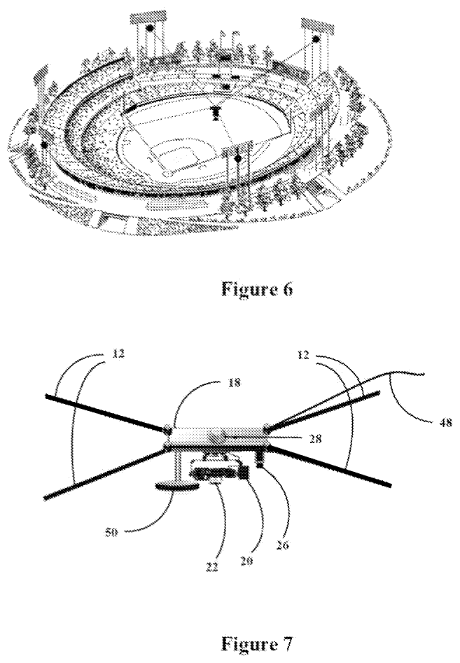

Alternatively, in some embodiments of the present invention, Dolly 18 includes a payload mount (not shown) adapted and configured for interchangeably holding Camera or Sensor 22. Alternatively, Dolly 18 additionally comprises an altitude meter 26, as shown in FIG. 7, positioned in a Nadir angle “A”, as illustrated in FIG. 2, measuring the altitude of the camera/sensor above the grass-turf. The altitude meter is coupled to the control device and provides data of the altitude of Camera or Sensor 22 to the control device, which is used thereby to keep Camera or Sensor 22 at a fixed altitude according to the desired scanning survey of the grass-turf.

According to some embodiments of the present invention, the 3D Cable-Cam System 10 further includes an ambient light sensor 28, mounted on the dolly as shown in FIG. 7, which is coupled to the control device. The ambient light sensor can send light data to the control device, which uses the data to determine whether to launch, cancel or postpone a scanning survey according to pre-defined light conditions.

Alternatively, in some embodiments of the present invention, the 3D Cable-Cam system 10 further includes an ambient light module 50 as shown in FIG. 7, which is coupled to the control device. Ambient light module 50 includes led lights elements, such as “Daylight TRI-R” led elements or similar lighting modules and may also include a combination of LED lights and halogen or incandescent elements, which are adapted and configured for lighting in the NIR range. Such lighting elements provide a lighting similar to the spectra of daylight. The lighting module can project a strong enough light to the grass-turf from a distance of 5 m to 30 m, which allows scanning of the pitch even at night, as well as enhancing the light during the day under bad weather conditions or on a cloudy day or on certain areas of the grass-turf, which are in a shade. In FIG. 9, there are shown graphs of intensity vs. wavelength (in nanometers), graph 40 of a halogen light, graph 42 of a TRI-R led light, graph 44 of a combination of TRI-R led and halogen lights, and graph 46 of daylight. As can be noted, the intensity of the light of the combination of TRI-R led and halogen, is closest to daylight.

Optionally, in some embodiments of the present invention, the Analyzing Software is adapted and configured for detecting irrelevant objects including humans which appear in the acquired imagery, when scanning the grass-turf for detecting irregularities of the grass. If such detected objects conceal a certain area of the grass-turf, an area which exceeds a pre-defined size, the control device can move the camera or sensor to the area the grass-turf where the irrelevant objects have been detected at a later stage for re-acquisition of images.

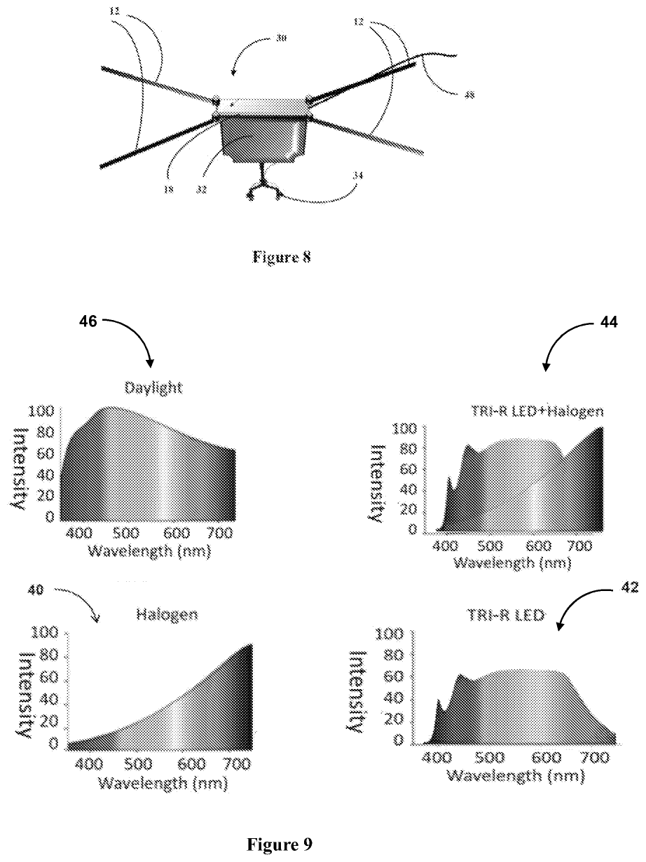

In an embodiment of the present invention, a spreading assembly 30, as shown in FIG. 8, can be mounted on Dolly 18. Alternatively, the spreading assembly can be formed as an integral part of gimbal stabilizer 20 of the Dolly, thereby providing pan and tilt of the spreading assembly allowing it to spread at Nadir angle “A” and/or oblique angle “B” (as shown in FIG. 2) as desired. Spreading assembly 30 comprises a container 32 for holding substances such liquids or chemicals, and optionally a spraying pump (not shown) and a single or multiple spreading nozzles or apertures 34. The spreading assembly can replace the Camera 22 or can be coupled thereto. The spreading assembly can be adapted and configured for spraying liquids such as water or nutrients or pesticides held in the container, through the nozzles or apertures, with or without the pump. Alternatively, an altitude/distance sensor can be coupled to spreading assembly 30.

In an embodiment of the present invention, nozzles or apertures 34 of spreading assembly 30 can be mounted on Dolly 18. Alternatively, the spraying pump can also be mounted on the Dolly. Alternatively, nozzles or apertures 34 and/or the spraying pump can be formed as an integral part of gimbal 20, thereby providing pan and tilt of the spreading assembly, allowing it to spray at Nadir “A” and/or oblique “B” angles as desired. According to this embodiment, container 32 for holding liquids (pesticide and/or nutrients and/or water) can be positioned at a remote location and coupled to spreading nozzles or apertures 34, which are disposed on Dolly 18, by a pipe (not shown). The pipe will preferably be coupled to one of cables 12. Alternatively, the pipe can extend from the container to the nozzles or apertures directly.

There is also provided, according to the present invention, a method for autonomously conducting a scanning survey of a grass-turf of stadiums, the method includes providing a 3D Cable-Cam System as described herein-above, controlling the path of motion of the Camera or Sensor, scanning the grass-turf, acquiring Imagery of the grass-turf, storing the Imagery, positioning the Imagery, and stitching the Imagery. Alternatively, the step of controlling includes controlling the path of motion of the Camera or Sensor to capture the imagery with minimal side and top overlapping of images. Alternatively, the step of positioning includes positioning the Imagery according to GPS or grid mapping. Alternatively, the step of positioning includes positioning the Imagery according to chessboard like grid mapping. Alternatively, the step of stitching includes creating an orthophoto by stitching the Imagery

There is also provided, according to an embodiment of the present invention, a method for autonomously conducting a scanning survey of a grass-turf of stadiums and maintaining the grass-turf based on the scanning survey as necessary to keep it in optimal condition. The method includes providing a 3D Cable-Cam System as described herein-above, controlling the path of motion of the Camera or Sensor, scanning the grass-turf, acquiring Imagery of the grass-turf, storing the Imagery, positioning the Imagery, stitching the Imagery, detecting areas of the grass-turf suspected of being damaged or in a deficient condition, and performing maintenance actions as necessary to keep such areas in optimal condition. Alternatively, the step of detecting includes a step of analyzing the Imagery. Alternatively, the step of detecting includes at least one additional step of scanning, acquiring additional Imagery of the areas of the grass-turf suspected of being damaged or in a deficient condition, storing the additional Imagery, positioning the additional Imagery, stitching the additional Imagery, and analyzing the additional Imagery. Alternatively, the step of analyzing includes a step of determining the maintenance actions necessary to perform on such areas of the grass-turf to maintain it in optimal condition.

There is also provided, according to the invention, a method for broadcasting and/or documenting sports games and/or sports practice and/or concerts and/or any event being performed on a grass-turf 11 (which shall be referred to herein as the “Events”), the method comprising the steps of providing a 3D Cable-Cam System 10 as described herein-above, controlling the path of motion of Camera or Sensor 22 to capture imagery with minimal side and top overlapping of images, scanning the grass-turf, capturing Imagery of the Events, positioning the Imagery according to a grid mapping 36 for facilitating stitching of the orthophoto, and broadcasting and/or storing the orthophoto.

Alternatively, the step of controlling the path of motion of the Camera or Sensor can include a step of programing the control device to capture the Imagery with no (or minimal) overlapping of the images, positioning the Imagery in a chessboard like grid mapping 38, as shown in FIG. 5, and combining the Imagery, if required, to display the Imagery of the entire pitch.

As mentioned above, in both positioning steps, with or without overlapping, either GPS or grid mapping 36 or chessboard like grid mapping 38, can be used for accurate positioning.

### General Comments

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will prevail. In addition, the materials, methods, and examples are illustrative only and are not intended to be necessarily limiting.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A 3D cable-system for collecting imagery of the grass-turf and or of events taking place thereon, the 3D cable-system comprising:
a cable assembly including:
a plurality of cables, each one of said cables is having a first end and a second end;
a dolly;
a plurality of motorized winches, each one of said plurality of motorized winches is coupled to a post or tower;
said first end of each cable is coupled to said one of said plurality of motorized winches and said second end of each cable is coupled to the dolly;
a camera or sensor payload mounted on said dolly and can acquire imagery including still images and/or video streams of the grass-turf and/or of events taking place thereon, for:
a. monitoring the condition of the grass-turf for detecting an irregularity and/or a deficient condition of the grass-turf comprising at least one member of a group consisting of tear, bad health, lack of vigor, dryness, wetness, nutrient deficiency, diseases, and pests; and/or
b. providing video streams for broadcasting;
a memory storage for storing the acquired imagery;
a control device coupled to said dolly, said camera or sensor and said at least one of said plurality of motorized winches, wherein said control device is adapted and configured for:
c. conducting a scanning survey of at least a part of the grass-turf by moving the dolly and/or said camera or sensor over said at least a part of the grass-turf according to a pre-set plan; and/or
d. triggering said camera or sensor to acquire said imagery;
a processing device, adapted and configured for transmitting and/or for broadcasting of said imagery.

2. The 3D cable-system according to claim 1, wherein said post or tower is disposed adjacent the grass-turf.

3. The 3D cable-system according to claim 1, wherein said first end of each cable is coupled to said post or tower via at least one of said motorized winches having a computerized controller and anchored to said post or tower.

4. The 3D cable-system according to claim 3, wherein said control device is coupled to said computerized controller and/or dolly and/or camera or sensor via at least one member of a group consisting of a wireless electronic means, an electric wire and an optical fiber connection, and wherein said computerized controller is adapted and configured for positioning said camera or sensor and/or dolly at a pre-set altitude over the grass-turf.

5. The 3D cable-system according to claim 1, wherein said processing device includes software disposed in at least one member of a group comprising of said processor device, said control device and/or a remote processor, adapted and configured for processing and conducting an analysis of at least a part of the acquired imagery by using agricultural metrics comprising at least one member of a group including NDVI, ARVI, ENDVI, SAVI, TGI, CGI, MCGI, and/or any combination of said metrics, and by conducting bands separation and/or alignment and/or relative illumination correction and/or radiometric calibration, thereby detecting said irregularities and/or deficient condition of the grass-turf.

6. (canceled)

7. The 3D cable-system according to claim 1, wherein said dolly additionally comprises a payload mount adapted and configured for interchangeably mounting of said camera or sensor on said mount.

8. The 3D cable-system according to claim 1, wherein said camera or sensor is mounted on a gimbal stabilizer coupled to said dolly, said gimbal stabilizer is adapted and configured for stabilizing the camera or sensor at any desired angle including a nadir angle, thereby acquiring imagery from optimal angles of imagery acquisition.

9. The 3D cable-system according to claim 7, wherein a spreading assembly is mounted on said dolly, and wherein said gimbal stabilizer provides pan and tilt to said spreading assembly allowing said spreading assembly to spread at a desired angle.

10. The 3D cable-system according to claim 8, wherein said spreading assembly further comprises a spraying pump mounted on the dolly and is adapted and configured for spraying liquids.

11. The 3D cable-system according to claim 1, wherein said camera or sensor payload is at least one member of a group of cameras or sensors comprising of an RGB, a multispectral, a hyperspectral, a Lidar and IR cameras or sensors, or any combination of said cameras or sensors, all operating in an automated process, and adapted and configured for acquiring said imagery of the grass-turf for detecting said irregularities and/or deficient condition of the grass-turf, and/or of events comprising at least one member of a group including sports, sport practice, games, events, all being conducted on the grass-turf, for broadcasting and/or documenting.

12. The 3D cable-system according to claim 1, wherein said camera or sensor payload comprises a dual-purpose camera or sensor capable of acquiring video streams or multispectral images by a simple interchange of a lens of said camera or sensor, and wherein said dual-purpose camera or sensor is adapted and configured for conducting a scanning survey of the grass-turf for monitoring the condition of the grass-turf, and providing video streams of events taking place on said grass-turf for broadcasting.

13. The 3D cable-system according to claim 1, wherein said pre-set plan is adapted and configured for creating a virtual 3D box space over the grass-turf, for moving said dolly inside said box, by the control device.

14. The 3D cable-system according to claim 1, wherein said software is further adapted and configured for detecting said irregularity and/or an irrelevant object on an area of said at least part of the grass-turf, and for providing said control device with a scanning plan for conducting a re-requisition of the imagery of said irregularity and/or irrelevant object.

15. The 3D cable-system according to claim 1, further comprises a GPS module for documenting the GPS Guidance Package of every acquired still image of the scanning survey of the grass-turf, thereby determining the exact location of an irregularity and/or irrelevant object on the grass-turf and moving said camera or sensor to said area of said at least part of the grass-turf on which said irregularity and/or an irrelevant object has been detected for acquiring refined details for performing a “leaf-level” AI analysis.

16. The 3D cable-system according to claim 5, wherein said software is further adapted and configured for determining based on said analysis, to selectively spread on said area of said at least part of the grass-turf having said irregularity, at least one substance of a group comprising liquids, water, nutrients or pesticides.

17. (canceled)

18. The 3D cable-system according to claim 1, wherein said software further includes a classifier for identifying said grass-turf irregularities.

19. The 3D cable-system according to claim 1, further comprising an ambient light sensor mounted on the dolly, said light sensor is coupled to said control device for sending a light data to said control device, wherein said data is used by said control device for determining whether to launch, cancel or postpone a scanning survey of the grass-turf according to pre-defined light conditions.

20. The 3D cable-system according to claim 1, further comprising a light module mounted on said dolly and coupled to said control device, said light module is adapted and configured for providing light in the NIR range, and includes at least one member of a group comprising a “Daylight TRI-R” led light element, a LED light element, a halogen light element, an incandescent light element, or any combination of said light elements, wherein said light module enhances the light on the grass-turf, thereby allowing to conduct the scanning survey of the grass-turf under low light conditions or at night.

21. The 3D cable-system according to claim 1, further comprising an altitude meter mounted on said dolly and coupled to said control device, said altitude meter is adapted and configured for measuring the altitude of the camera or sensor above the grass-turf, and for providing data of the altitude of said camera or sensor to said control device, thereby positioning said camera or sensor at an altitude according to said pre-set plan of the scanning survey of the grass-turf.

22. A method for monitoring a grass-turf and or events taking place thereon, the method comprising the steps of:
providing a cable assembly including:
a plurality of cables, each one of said cables is having a first end and a second end;
a dolly;
a plurality of motorized winches, wherein each one of said plurality of motorized winches is coupled to a post or tower and wherein said first end of each cable is coupled to said one of said plurality of motorized winches and said second end of each cable is coupled to said dolly;
providing a camera or sensor payload mounted on said dolly;
acquiring by said camera or sensor imagery including still images and/or video streams of the grass-turf and/or of events taking place thereon;
monitoring the condition of the grass-turf;
detecting an irregularity and/or a deficient condition of the grass-turf comprising at least one member of a group consisting of tear, bad health, lack of vigor, dryness, wetness, nutrient deficiency, diseases and pests; and/or
providing video streams for broadcasting;
providing a memory storage for storing the acquired imagery;
providing a control device and coupling said control device to said dolly and/or said camera or sensor and/or said at least one of said plurality of motorized winches;
conducting by said control device a scanning survey of at least a part of the grass-turf by moving the dolly and/or said camera or sensor over said at least a part of the grass-turf according to a pre-set plan; and/or
triggering by said control device said camera or sensor for acquiring said imagery;
providing a processing device, adapted and configured for transmitting and/or for broadcasting of said imagery;
conducting an analysis of at least a part of the acquired imagery by software adapted and configured therefor.

23. (canceled)

24. The method of claim 22, additionally comprising a step of positioning said at least a part of said acquired imagery and creating an orthophoto by stitching.

25. (canceled)

26. (canceled)

27. (canceled)

28. The method according to claim 22, additionally comprising a step of controlling the path of motion of said camera or sensor and/or dolly for acquiring said imagery with minimal side and top overlapping of images.

29. (canceled)

30. An autonomously method for monitoring a grass-turf and/or events taking place thereon, the method comprising the steps of:
conducting a scanning survey by a camera or sensor of at least part of said grass-turf and/or said
events;
controlling the path of motion of said camera or sensor;
acquiring images of said at least part of said grass-turf and/or said events;
storing said acquired images;
positioning said acquired images;
stitching said acquired images;
detecting areas of said at least part of said grass-turf and/or said events suspected of being damaged or in a deficient condition;
analyzing the acquired images and determining the maintenance actions necessary to perform on or to said areas.

31. (canceled)

32. (canceled)

33. (canceled)
